(19) United States
(12) Patent Application Publication
(10) Pub. No.: US 2009/0135143 A1
(43) Pub. Date: May 28, 2009

(54) CHARACTER INPUT METHOD AND ELECTRONIC DEVICE USING THE SAME

(75) Inventors: Chang-beom SHIN, Seoul (KR); O-jae Kwon, Seoul (KR); Han-chul Jung, Seoul (KR); Bo-suk Ham, Cheonan-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/101,436

(22) Filed: Apr. 11, 2008

(30) Foreign Application Priority Data
Nov. 27, 2007 (KR) 2007-121720

(51) Int. Cl. G06F 3/02

(52) U.S. Cl. 345/168; 345/156

(57) ABSTRACT

A character input method and an electronic device. According to the character input method, if a plurality of characters are input together by a user substantially simultaneously, the electronic device may recognize that the user desires to input a character other than the plurality of characters. Therefore, it is possible to reduce the number of keys required to input characters, so an electronic device requiring character keys can be greatly reduced in size.

### CROSS-REFERENCE TO RELATED APPLICATION

This application claims the benefit of Korean Application No. 2007-121720, filed in the Korean Intellectual Property Office on Nov. 27, 2007, the disclosure of which is incorporated herein by reference.

### BACKGROUND OF THE INVENTION

1. Field of the Invention

Aspects of the present invention relate to a character input method and an electronic device using the method, and more particularly, to a method of receiving characters input by a user using character keys, and an electronic device using the method.

2. Description of the Related Art

The explosive growth in Internet use has made it possible to use the Internet in home appliances such as televisions (TVs). Additionally, the development of wireless Internet technologies has enabled users to use the Internet using mobile devices. When the Internet is used, there is a need to input characters. Due to the use of keyboards, people are very familiar with character input in a key input scheme.

However, such a key input scheme is inappropriate for remote controllers of TVs and mobile devices. This is because the key input scheme causes remote controllers and mobile devices, which are required to be made compact, to increase in size. Therefore, there is a need for methods for reducing the number of keys to be included to enable input using a compact key set.

### SUMMARY OF THE INVENTION

Aspects of the present invention provide a character input method and an electronic device using the method, in which, when a user presses a plurality of character keys together, the electronic device is able to recognize input of characters other than the plurality of characters, in order to reduce the number of keys required to input characters.

According to an aspect of the present invention, a method of inputting characters is provided. The method comprises receiving one or more characters input by a user; and if a plurality of characters are input substantially simultaneously by the user, recognizing that the user desires to input a character other than the plurality of characters.

According to another aspect of the present invention, the character which the user desires to input is a character having a predetermined relationship with one of the plurality of characters. Two characters may be input together by the user.

According to another aspect of the present invention, the character having a predetermined relationship with one of the plurality of characters is one of a character derived from one of the plurality of characters, a character having a similar appearance to one of the plurality of characters, a character derived from a character having a similar appearance to one of the plurality of characters, a character alphabetically adjacent to one of the plurality of characters, and/or a character from among characters visually displayed on an input unit to input the plurality of characters.

According to another aspect of the present invention, marks visually connecting the plurality of characters are displayed on the input unit on which the character having a predetermined relationship with one of the plurality of characters is displayed.

According to another aspect of the present invention, the one or more characters are input by the user using one of a physical user interface (PUI) and a graphical user interface (GUI).

According to another aspect of the present invention, the character which the user desires to input is a character frequently used by the user.

According to another aspect of the present invention, an electronic device is provided. The electronic device comprises a user input unit to receive characters input by a user; and a controller wherein, if a plurality of characters are input together via the user input unit, the controller recognize that the user desires to input a character other than the plurality of characters.

According to another aspect of the present invention, the character which the user desires to input may be a character having a predetermined relationship with one of the plurality of characters. Here, two characters may be input together by the user.

According to another aspect of the present invention, the character having a predetermined relationship with one of the plurality of characters is one of a character derived from one of the plurality of characters, a character having a similar appearance to one of the plurality of characters, a character derived from a character having a similar appearance to one of the plurality of characters, a character alphabetically adjacent to one of the plurality of characters, and/or a character from among characters visually displayed on the input unit.

According to another aspect of the present invention, marks visually connecting the plurality of characters are displayed on the input unit on which the character having a predetermined relationship with one of the plurality of characters is displayed.

According to another aspect of the present invention, the input unit is a physical user interface (PUI) or a graphical user interface (GUI).

According to another aspect of the present invention, the character which the user desires to input may be a character frequently used by the user.

According to another aspect of the present invention, a user input method is provided. The method comprises receiving input from one or more keys pressed by a user; and if a plurality of keys are pressed substantially simultaneously by the user, recognizing the plurality of keys pressed by the user to be commands to input functions other than functions mapped to the individual keys.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A to 1D are diagrams of keypads and displays to explain a method of inputting characters in a multi-key input scheme;

FIG. 2 is a diagram of a keypad and a display to explain a method of inputting Latin alphabetic characters in a multi-key input scheme;

FIGS. 3A to 3C are diagrams of keypads and displays to explain various methods of inputting Korean consonants in a multi-key input scheme;

FIG. 4 is a diagram of a keypad to explain a method of inputting Korean vowels in a multi-key input scheme;

FIGS. 5A to 5C are diagrams of keypads to explain a method of inputting Korean and Latin alphabetic characters in a multi-key input scheme;

FIG. 6 is a block diagram of an electronic device capable of performing a method of inputting characters according to an embodiment of the present invention;

FIG. 7 is a flowchart to explain a method of inputting characters according to an embodiment of the present invention;

FIG. 8 is a diagram of a keypad to explain a method of inputting characters according to another embodiment of the present invention; and

FIG. 9 is a diagram of a keypad to explain a method of inputting characters according to still another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

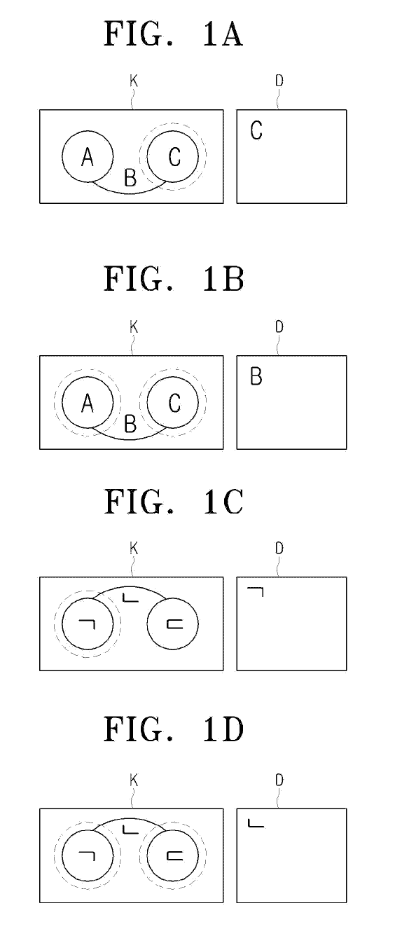

FIGS. 1A to 1D show keypads K and displays D to explain a process of inputting characters in a multi-key input scheme. In the multi-key input scheme, a single character may be input by pressing a single key, or by pressing two keys together.

As shown in FIG. 1A, the keypad K and a display D are shown on the left and right, respectively. The keypad K comprises keys A and C, and the key C is circumscribed by a dotted line, indicating that a user has pressed the key C. Keys indicated by dotted lines indicate that the keys have been pressed by the user. If the user presses the key C, the character selected by the user, namely “C”, is displayed on the display D, as shown in FIG. 1A.

A character “B” is printed on the keypad K together with a curved line to connect the keys A and C. The curved line and “B” indicates that when the keys A and C are pressed together, “B” is displayed on the display D. Accordingly, if the user presses the keys A and C together, “B” is displayed on the display D, as shown in FIG. 1B.

The process of inputting characters in the multi-key input scheme as described above may also be applied to Korean characters. For example, if the user presses a key [symbol] , the character [symbol] may be displayed on the display D, as shown in FIG. 1C. Alternatively, if the user presses keys [symbol] and [symbol] simultaneously, [symbol] which is printed between the keys [symbol] and [symbol] may be displayed on the display D, as shown in FIG. 1D.

Accordingly, as shown in FIGS. 1A to 1D, if the user presses two character keys together, a character placed between two characters corresponding to the two character keys pressed by the user may be displayed. For example, if the user presses the keys A and C together, “B”, which comes between “A” and “C” alphabetically, may be displayed, as shown in FIG. 1B. Similarly, if the user presses the keys [symbol] and [symbol] together, [symbol] which comes between [symbol] and [symbol] in the traditional Korean order, may be displayed, as shown in FIG. 1D.

A character alphabetically adjacent to a character corresponding to one of two character keys pressed by the user may be displayed. For example, if a user presses the keys A and C together, “B”, which succeeds “A” and precedes “C”, may be displayed. Such interpretation may also be applied to inputting Korean characters.

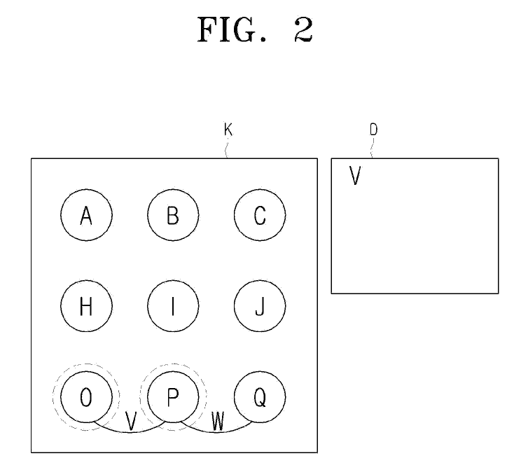

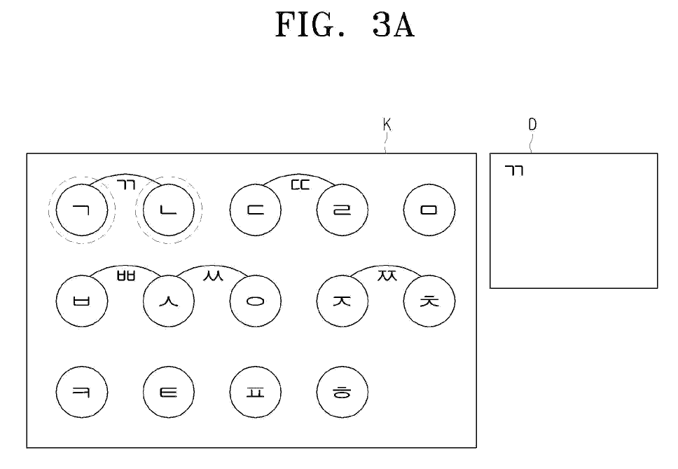

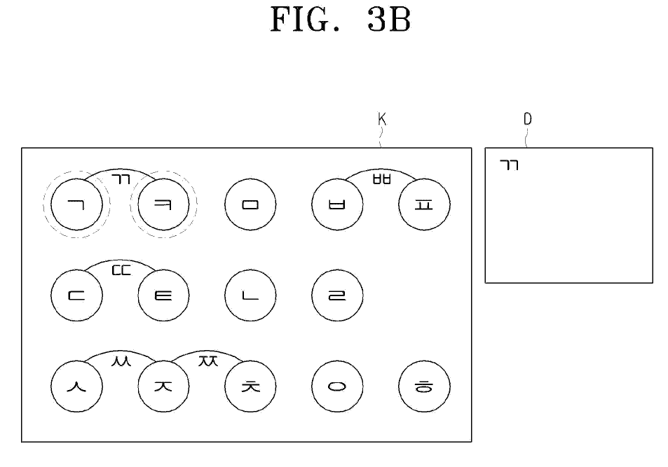

Another process of inputting Latin alphabetic characters in the above-described multi-key input scheme will be described in detail with reference to FIG. 2. In FIG. 2, if the user presses keys O and P together, “V”, which is printed between the keys O and P, may be displayed on the display D. If the user presses keys P and Q using a keypad K of FIG. 2, “W”, which is printed between the keys P and Q, may be displayed on the display D. Accordingly, if the user presses two character keys together, a character other than the two characters corresponding respectively to the two character keys pressed by the user may be displayed. A character printed between the two character keys pressed by the user may be displayed.

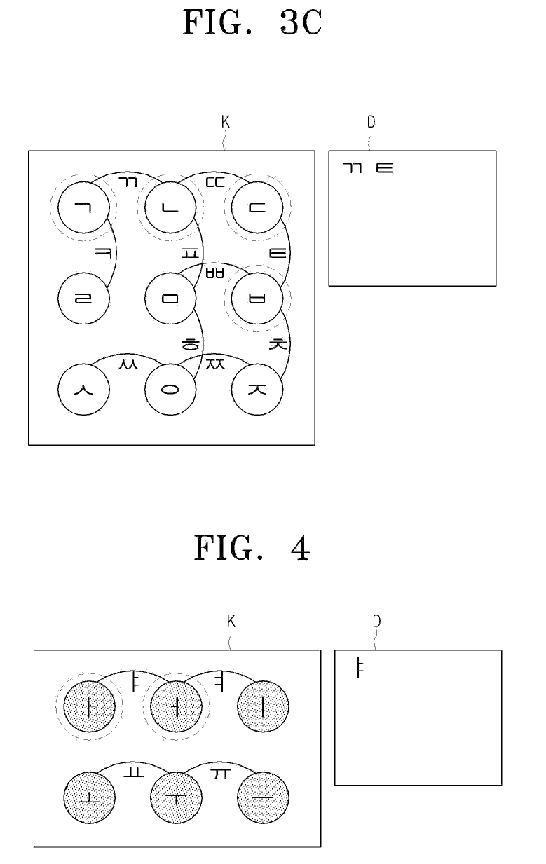

FIG. 3A shows another process of inputting Korean consonants in the multi-key input scheme. As shown in FIG. 3A, if the user presses keys [symbol] and [symbol] together, a geminate consonant “ [symbol] ” derived from [symbol] may be displayed on the display D. Referring to a keypad K shown in FIG. 3A, if keys [symbol] and [symbol] are pressed together, a geminate consonant [symbol] derived from [symbol] may be displayed on the display D. If keys [symbol] and [symbol] are pressed together, a geminate consonant [symbol] derived from [symbol] may be displayed on the display D; if keys [symbol] and [symbol] are pressed together, a geminate consonant [symbol] derived from [symbol] may be displayed on the display D. If keys [symbol] and [symbol] are pressed together, a geminate consonant [symbol] derived from [symbol] may be displayed on the display D.

Accordingly, as shown in FIG. 3A, if the user presses two character keys together, a character derived from a character corresponding to the left-hand character key of the two pressed keys on the keypad K may be displayed. For example, if the user presses the keys [symbol] and [symbol] together, a geminate consonant [symbol] derived from [symbol] corresponding to the left-hand key [symbol] of the two pressed keys on the keypad K may be displayed on the display D.

Another process of inputting Korean consonants in the multi-key input scheme will be described in detail with reference to FIG. 3B. A keypad K shown in FIG. 3B comprises the same keys as the keypad K shown in FIG. 3A. However, the keys of the keypads K shown in FIGS. 3A and 3B are arranged differently. While the keys of the keypad K shown in FIG. 3A are arranged in the order of Korean consonants, the keys of the keypad K shown in FIG. 3B are arranged in such a manner that keys indicating aspirated consonants [symbol] are placed to the right of keys indicating plain consonants [symbol] respectively, which have both aspirated and geminate equivalents.

Keys indicating the plain consonants [symbol] [symbol] which are similar in appearance to the plain consonants [symbol] [symbol] respectively, which have only a geminate equivalent and does not have an aspirated equivalent, are placed to the right of the keys [symbol] [symbol] on the keypad K of FIG. 3B. A key indicating the aspirated consonant [symbol] is placed to the right of the key indicating the plain consonant [symbol] which has only an aspirated equivalent and does not have a geminate equivalent, on the keypad K of FIG. 3B.

As shown in FIG. 3B, if the user presses the keys [symbol] and [symbol] together, the geminate consonant [symbol] derived from [symbol] may be displayed on the display D. If keys [symbol] and [symbol] are pressed together, the geminate consonant [symbol] derived from [symbol] may be displayed on the display D; if keys [symbol] and [symbol] are pressed together, the geminate consonant [symbol] derived from [symbol] may be displayed on the display D; if keys [symbol] and [symbol] are pressed together, the geminate consonant [symbol] derived from [symbol] may be displayed on the display D; and if keys [symbol] and [symbol] are pressed together, the geminate consonant [symbol] derived from [symbol] may be displayed on the display D.

Accordingly, if the user presses two character keys together, a geminate consonant derived from a consonant corresponding to the left-hand character key of the two pressed keys on the keypad K may be displayed on the display D. Additionally, if the user presses two character keys together, a consonant having a similar appearance to a character corresponding to the right-hand character key of the two pressed keys on the keypad K may be displayed. This is because pairs of consonants, such as [symbol] and [symbol] and [symbol] [symbol] and [symbol] [symbol] and [symbol] and [symbol] and [symbol] have similar appearances.

Another process of inputting Korean consonants in the multi-key input scheme will be described in detail with reference to FIG. 3C. As shown in FIG. 3C, if the user presses the keys [symbol] and [symbol] together, the geminate consonant [symbol] derived from [symbol] may be displayed on a display D. Additionally, if the user presses the keys [symbol] and [symbol] together, the aspirated consonant [symbol] derived from [symbol] may be displayed on the display D.

Referring to the keypad K of FIG. 3C, if keys [symbol] and [symbol] are pressed together, the geminate consonant [symbol] derived from [symbol] may be displayed on the display D; if keys [symbol] and [symbol] are pressed together, the geminate consonant [symbol] derived from [symbol] may be displayed on the display D; if keys [symbol] and [symbol] are pressed together, the geminate consonant [symbol] derived from [symbol] may be displayed on the display D; and if keys [symbol] and [symbol] are pressed together, the geminate consonant [symbol] derived from [symbol] may be displayed on the display D. Accordingly, a geminate consonant derived from a consonant that has a geminate equivalent may be displayed from among two consonants corresponding to two character keys pressed by the user. In this situation, the two character keys pressed by the user are adjacent horizontally.

Additionally, referring to the keypad K of FIG. 3C, if the keys [symbol] and [symbol] are pressed together, the aspirated consonant [symbol] derived from [symbol] may be displayed on the display D, and if the keys [symbol] and [symbol] are pressed together, the aspirated consonant [symbol] derived from [symbol] having a similar appearance to [symbol] may be displayed on the display D. Furthermore, if the keys [symbol] and [symbol] are pressed together, the aspirated consonant [symbol] derived from [symbol] may be displayed on the display D, and if the keys [symbol] and [symbol] are pressed together, the consonant [symbol] having a similar appearance to [symbol] may be displayed on the display D.

Accordingly, if the keypad K of FIG. 3C is used, the aspirated consonants [symbol] [symbol] [symbol] derived from the consonants [symbol] [symbol] [symbol] respectively; the aspirated consonant [symbol] derived from [symbol] having a similar appearance to [symbol] or the consonant [symbol] having a similar appearance to [symbol] may be displayed when two character keys are pressed together by the user. In this situation, the two character keys pressed by the user are adjacent to each other vertically.

A process of inputting Korean vowels in the multi-key input scheme will be described in detail with reference to FIG. 4. As shown in FIG. 4, if the user presses keys [symbol] and [symbol] together, the diphthong [symbol] derived from [symbol] may be displayed on a display D. If the user presses keys [symbol] and | together, the diphthong [symbol] derived from [symbol] may be displayed on the display D. If the user presses keys [symbol] and [symbol] together, the diphthong [symbol] derived from [symbol] may be displayed on the display D. If the user presses keys [symbol] and — together, the diphthong [symbol] derived from [symbol] may be displayed on the display D.

Accordingly, if the user presses two character keys together, a character derived from a character corresponding to the left-hand character key of the two pressed keys on the keypad K of FIG. 4 may be displayed. For example, if the user presses the keys [symbol] and [symbol] together, the diphthong [symbol] derived from the monophthong [symbol] corresponding to the left-hand key [symbol] of the two pressed keys on the keyboard K of FIG. 4 may be displayed on a display D.

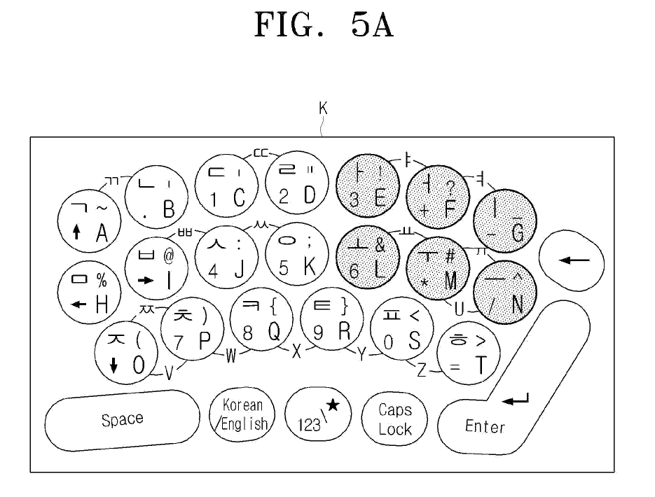

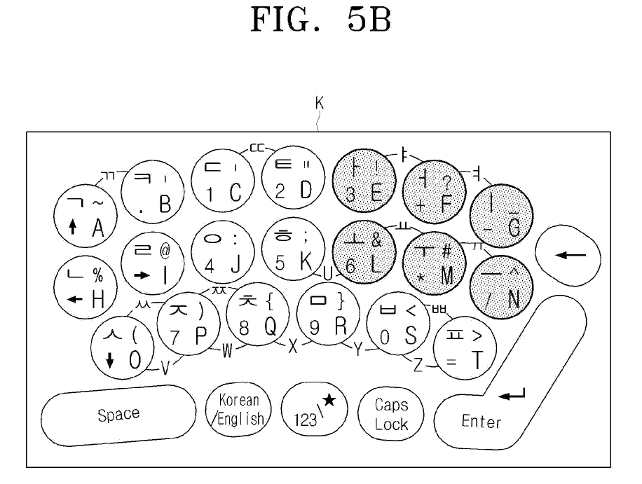

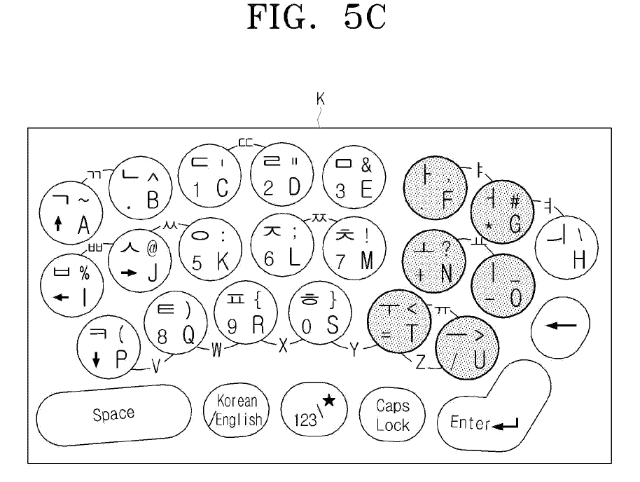

A process of inputting Korean and Latin alphabetic characters in the multi-key input scheme will be described in detail with reference to FIGS. 5A to 5C. The process of inputting Korean and Latin alphabetic characters based on FIG. 5A is associated with the processes of inputting Latin alphabetic characters, Korean consonants and Korean vowels based on FIGS. 2, 3A and 4. A keypad K shown in FIG. 5A comprises Korean plain consonant keys [symbol] [symbol] Korean aspirated consonant keys [symbol] and Korean monophthong keys [symbol] Here, the keys are arranged according to their respective natural orders, though the keys may be arranged differently in other aspects of the invention, such as by usage.

A user may press only a single key using the keypad K of FIG. 5A in order to input one of the plain consonants [symbol] [symbol] the aspirated consonants [symbol] [symbol] and the monophthongs [symbol] If the user desires to input the geminate consonants [symbol] he may press plain consonant keys [symbol] together with keys to the right of each respective plain consonant key, using the keypad K of FIG. 5A. The keys to the right of the plain consonant keys may also be used when the user wishes to input a character succeeding a character appearing on the plain consonant key. For example, the user may press the key [symbol] together with [symbol] in order to input “ [symbol] ”. In this situation, the key [symbol] is placed to the right of the key [symbol] and may be used to input [symbol] or to input a character [symbol] The user may input the character [symbol] by pressing the keys [symbol] and [symbol] input the character [symbol] by pressing the keys [symbol] and [symbol] input the character [symbol] by pressing the keys [symbol] and [symbol] and input the character [symbol] by pressing the keys [symbol] and [symbol] using the keypad K of FIG. 5A.

Moreover, the keypad K shown in FIG. 5 also comprises Latin alphabetic letter keys A to T, but not U to Z. Here, only a single key indicating each letter may be pressed in order to input letters “A” to “T”. However, if the user desires to input letters “U” to “Z”, he may press two letters together using the keypad K of FIG. 5A. If the user presses pairs of keys M and N, O and P, P and Q, Q and R, R and S, and S and T, letters “U”, “V”, “W”, “X”, “Y” and “Z” may be input, respectively.

Another process of inputting Korean and Latin alphabetic characters in the multi-key input scheme will be described in detail with reference to FIG. 5B. The process of inputting Korean and Latin alphabetic characters based on FIG. 5B is associated with the processes of inputting Latin alphabetic characters, Korean consonants and Korean vowels based on FIGS. 2, 3B and 4. A keypad K shown in FIG. 5B comprises the same keys as the keypad K shown in FIG. 5A. However, the keys of the keypads K shown in FIGS. 5A and 5B are arranged differently. The keys of the keypads K shown in FIG. 5A are arranged in their respective natural orders.

Keys indicating the aspirated consonants [symbol] are placed to the right of keys indicating the plain consonants [symbol] respectively, which have both aspirated and geminate equivalents, on the keypads K shown in FIG. 5B. Additionally, keys indicating the plain consonants [symbol] [symbol] which are similar in appearance to the plain consonants [symbol] [symbol] respectively, which have only a geminate equivalent and does not have an aspirated equivalent, are placed to the right of the keys [symbol] [symbol] The key indicating the aspirated consonant [symbol] is placed to the right of the key indicating the plain consonant [symbol] which has only an aspirated equivalent and does not have a geminate equivalent.

In this situation, a user may press only a single key using the keypad K of FIG. 5B in order to input one of the plain consonants [symbol] [symbol] the aspirated consonants [symbol] and the monophthongs [symbol] If the user desires to input geminate consonants [symbol] he may press keys on which plain consonants [symbol] [symbol] appear, together with keys to the right of the keys indicating the plain consonants [symbol] respectively, using the keypad K of FIG. 5B. The keys to the right of the keys for the plain consonants [symbol] may be the aspirated consonants [symbol] derived from the plain consonants [symbol] respectively, or the consonants [symbol] [symbol] that are similar in appearance to the plain consonants [symbol] [symbol] respectively. The Korean vowels and Latin alphabetic characters may be input using the keypad K of FIG. 5B in substantially the same manner as in the situation in which the keypad K of FIG. 5A is used, so detailed description thereof will be omitted.

A keypad K shown in FIG. 5C comprises Korean consonant keys on the left, and Korean vowel keys on the right, and is thus distinct from the keypads K shown in FIGS. 5A and 5B described above. The keypad K shown in FIG. 5C further comprises a key indicating the most frequently used diphthong [symbol] and accordingly, may also provide a key U which is not included in the keypads K shown in FIGS. 5A and 5B. The process of inputting Korean and Latin alphabetic characters using the keypad K shown in FIG. 5C may be easily performed based on the descriptions of FIGS. 5A and 5B, so a detailed description thereof will be omitted.

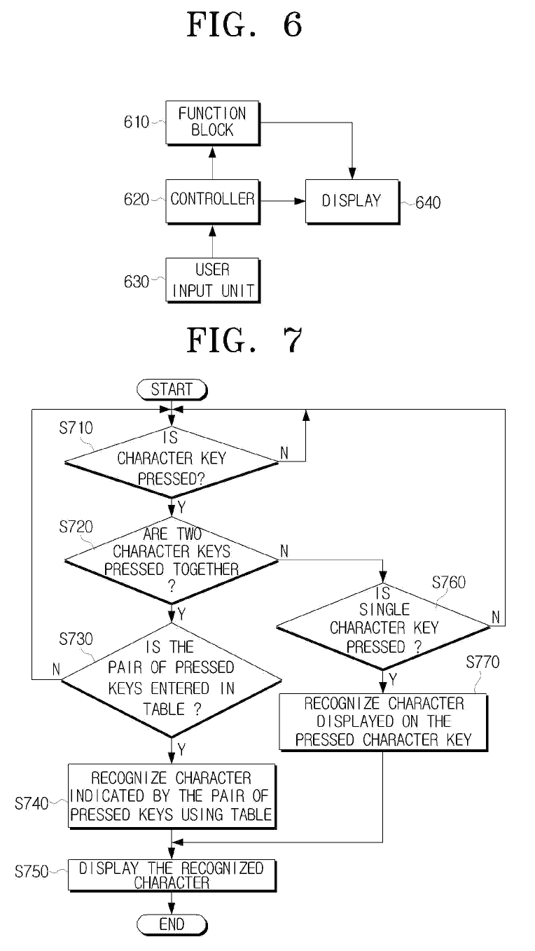

FIG. 6 shows an electronic device capable of performing the character input methods described above. The electronic device of FIG. 6 comprises a function block 110, a controller 120, a user input unit 130 and a display 140. The function block 110 performs the original functions of the electronic device. For example, if the electronic device is an electronic dictionary, the function block 110 may maintain and provide dictionary information; if the electronic device is a hand-held PC, the function block 110 may launch programs installed in the PC and perform various functions according to user commands. Alternatively, if the electronic device is a key input device, the function block 110 may transmit information input by a user in a key input scheme to another electronic device.

The user input unit 130 is used to transfer operation commands input by the user to the controller 120. The keypad K is used as an example of the user input unit 130. The display 140 displays visual information output from the function block 110 or the controller 120. In this embodiment of the present invention, the display D is used as a display 140. The display 140 may be omitted from the electronic device depending on the functions of the electronic device. For example, if the electronic device is a key input device such as a keyboard or a remote controller to transfer user operation commands to another electronic device, the display 140 may be omitted.

The controller 120 may control the function block 110, or may change information displayed on the display 140 according to the user operation commands input by the user input unit 130. Additionally, the controller 120 may recognize which character is input by the user using character keys on the user input unit 130. If the user presses only a single character key, the controller 120 may recognize input of a character corresponding to the pressed character key. Additionally, if the user presses two character keys together, the controller 120 may recognize that a character other than characters corresponding to the pressed character keys is input.

In a situation in which the user presses two character keys, the controller 120 may recognize the character which is input using the methods based on FIGS. 5A to 5C. To achieve this, the controller 120 may use a table for recognizing multiple character input (hereinafter, referred to as a table) which is stored in a memory (not shown) of the electronic device. If the user input unit 130 functions as a keypad K shown in FIG. 5A, the following table may be used.

| Pairs of | Character | Pairs of | Character | Pairs of | Character |
|---|---|---|---|---|---|
| character | recog- | character | recog- | character | recog- |
| keys | nition | keys | nition | keys | nition |
| [symbol] + [symbol] | [symbol] | [symbol] + [symbol] | [symbol] | O + P | V |
| [symbol] + [symbol] | [symbol] | [symbol] + [symbol] | [symbol] | P + Q | W |
| [symbol] + [symbol] | [symbol] | [symbol] + [symbol] | [symbol] | Q + R | X |
| [symbol] + [symbol] | [symbol] | [symbol] + — | [symbol] | R + S | Y |
| [symbol] + [symbol] | [symbol] | M + N | U | S + T | Z |

A process by which the electronic device of FIG. 6 receives a character input by the user will be described in detail with reference to FIG. 7. FIG. 7 is a flowchart of a character input process according to an embodiment of the present invention. As shown in FIG. 7, if the user inputs a character key using the user input unit 130 in operation S710, the controller 120 measures the number of character keys pressed by the user in operations S720 and S760. In operations S720 and S760, the controller 120 determines whether the user presses a single character key or two character keys.

If two character keys are pressed, the controller 120 determines whether a pair of pressed character keys present in a table in operation S730. For example, if the pair of keys [symbol] and [symbol] is pressed, the pair of pressed keys may be present in the table, but if the pair of keys [symbol] and [symbol] is pressed, the pair of pressed keys is not present in the table.

If the pair of pressed character keys is present in the table, the controller 120 recognizes a character indicated by the pair of pressed character keys using the table in operation S740. The controller 120 displays the recognized character on the display 140 in operation S750. If the pair of pressed character keys is not present in the table, this process may be repeated from operation S710 regardless of whether the user presses character keys. If a single character key is pressed, the controller 120 recognizes a character displayed on the pressed character key in operation S770, and displays the recognized character on the display 140 in operation S750.

Although two character keys may be pressed together in the multi-key input scheme according to aspects of the present invention, aspects of the present invention is also applicable to a situation in which three or more character keys are pressed together in the multi-key input scheme.

Additionally, as described above, when two character keys are pressed, a character having a predetermined relationship with one of the two characters corresponding respectively to the two pressed keys is input, such as a character derived from one of the two characters corresponding to the two pressed keys, a character having a similar appearance to one of the two characters corresponding to the two pressed keys, a character derived from a character having a similar appearance to one of the two characters corresponding to the two pressed keys, a character alphabetically adjacent to one of the two characters corresponding to the two pressed keys, or a character printed between the two pressed keys. However, these are provided as examples in order to facilitate understanding of the present invention. Aspects of the present invention may be applied to a situation in which another character having a predetermined relationship with one of two characters corresponding to the pressed keys is input.

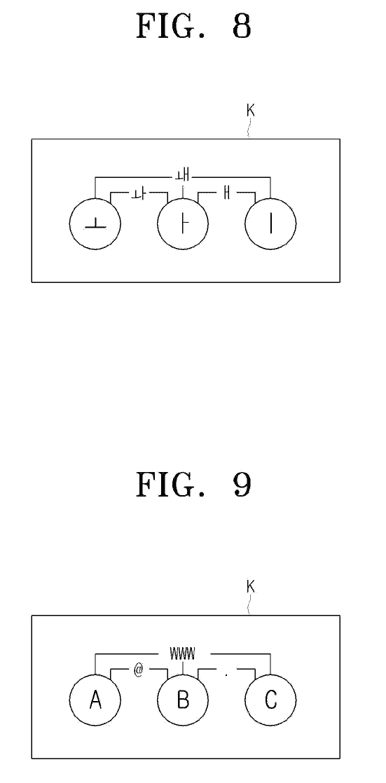

Furthermore, if the user presses a plurality of character keys, the electronic device may recognize a character created by combining a plurality of characters corresponding to the pressed plurality of character keys. For example, as shown in FIG. 8, if the user presses a key ├ together with a key [symbol] the electronic device may recognize that [symbol] is input; if the user presses a key [symbol] together with a key |, the electronic device may recognize that [symbol] is input; and if the user presses keys ├, [symbol] and | together, the electronic device may recognize that [symbol] is input.

Alternatively, if the user presses a plurality of character keys, the electronic device may recognize not only the above-described characters but also frequently used characters. For example, as shown in FIG. 9, if a pair of keys A and B, a pair of keys B and C, or all the keys A, B and C are pressed, characters or character strings such as “@”, “.”, or “www” which the user frequently uses may be input. Moreover, aspects of the present invention may be applied to special characters, so special characters such as “@” or “.” may be input.

Although the user may input characters using character keys on a physical user interface (PUI) of the present invention, other types of PUI may be used to input characters instead of a character key set. Accordingly, aspects of the present invention are also applicable to a graphical user interface (GUI) to input characters. Additionally, character keys are pressed by the user as described above for convenience of understanding, but other types of key may be used instead of character keys.

Accordingly, aspects of the present invention are also applicable to number keys or function keys. In this situation, if the user presses a plurality of keys once, commands for functions other than functions respectively mapped to the plurality of keys may be input. For example, if number keys 1 and 2 are pressed together, the electronic device may recognize that “12” has been input. Additionally, if function keys ▴ and ▾ are pressed together, the electronic device may recognize that a channel automatic search command has been input.

As described above, the operation of pressing together two character keys refers that two character keys are simultaneously pressed and released by the user. For example, the keys [symbol] and [symbol] may desirably be pressed and released at the same time using the keypad K of FIG. 1D. However, it is difficult to press and release keys at the exact same instant, so the situation in which the keys [symbol] and [symbol] are pressed together according to aspects of the present invention also includes situations in which the key [symbol] is pressed after the key [symbol] has been pressed, or situations in which the key [symbol] is pressed after the key [symbol] has been pressed. Additionally, there may be no limitation to the time required to press the keys [symbol] and [symbol] but a time may be set if required. For example, if the key [symbol] is pressed for approximately 0.5 seconds after the key [symbol] has been pressed, [symbol] may be displayed on the display D, but if not, [symbol] may continue to be displayed on the display D.

Although Korean and Latin alphabetic characters may be provided, aspects of the present invention may be applied to characters other than Korean and Latin alphabetic characters.

As described above, according to aspects of the present invention, if a plurality of character keys are pressed together by the user, the electronic device may recognize that a character other than characters corresponding to the pressed character keys is input. Accordingly, it is possible to reduce the number of keys required to input characters, so an electronic device including character keys can be greatly reduced in size.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of inputting characters, the method comprising:
receiving one or more characters input by a user; and
if a plurality of characters are input substantially simultaneously by the user, recognizing that the user desires to input a character other than the plurality of characters.

2. The method according to claim 1, wherein the character which the user desires to input is a character having a predetermined relationship with one of the plurality of characters.

3. The method according to claim 2, wherein two characters are input together by the user.

4. The method according to claim 2, wherein the character having a predetermined relationship with one of the plurality of characters is one of a character derived from one of the plurality of characters, a character having a similar appearance to one of the plurality of characters, a character derived from a character having a similar appearance to one of the plurality of characters, a character alphabetically adjacent to one of the plurality of characters, and/or a character from among characters visually displayed on an input unit to input the plurality of characters.

5. The method according to claim 4, wherein marks visually connecting the plurality of characters are displayed on the input unit on which the character having a predetermined relationship with one of the plurality of characters is displayed.

6. The method according to claim 2, wherein the one or more characters are input by the user using a physical user interface (PUI) or a graphical user interface (GUI).

7. The method according to claim 1, wherein the character which the user desires to input is a character frequently used by the user.

8. An electronic device comprising:
a user input unit to receive characters input by a user; and
a controller wherein, if a plurality of the characters are input via the user input unit substantially simultaneously, the controller recognizes that the user desires to input a character other than the plurality of characters.

9. The electronic device according to claim 8, wherein the character that the user desires to input is a character having a predetermined relationship with one of the plurality of characters.

10. The electronic device according to claim 9, wherein two characters are input substantially simultaneously by the user.

11. The electronic device according to claim 9, wherein the character having a predetermined relationship with one of the plurality of characters is one of a character derived from one of the plurality of characters, a character having a similar appearance to one of the plurality of characters, a character derived from a character having a similar appearance to one of the plurality of characters, a character alphabetically adjacent to one of the plurality of characters, and/or a character from among characters visually displayed on the input unit.

12. The electronic device according to claim 11, wherein marks visually connecting the plurality of characters are displayed on the input unit on which the character having the predetermined relationship with one of the plurality of characters is displayed.

13. The electronic device according to claim 9, wherein the input unit is a physical user interface (PUI) or a graphical user interface (GUI).

14. The electronic device according to claim 8, wherein the character which the user desires to input is a character frequently used by the user.

15. A user input method comprising:
receiving input from one or more keys pressed by a user; and
if a plurality of keys are pressed substantially simultaneously by the user, recognizing the plurality of keys pressed by the user to be commands to input functions other than functions mapped to the individual keys.

16. An electronic device, comprising:
a keyboard having a plurality of keys corresponding to individual characters of an alphabet, the keyboard having fewer keys than the number of letters in the alphabet;
a controller to receive key signals from the keyboard when a key is pressed and to interpret the key signal as a character mapped to the key;
wherein, when the controller receives two or more key signals substantially simultaneously, each corresponding to a press of a key, the controller interprets the two or more key signals as a character not mapped to any of the two or more keys.

17. The electronic device of claim 16, wherein, when the controller receives two or more key signals substantially simultaneously, the controller interprets the two or more key signals as a string of characters, at least one of which is not mapped to any of the two or more keys.

18. The electronic device of claim 16, wherein each of the plurality of keys is mapped to both a Korean character and an English character.

19. The electronic device of claim 16, wherein characters mapped to two more keys pressed simultaneously are used less often than characters mapped to an individual key.

20. The electronic device of claim 16, wherein the electronic device is a remote control.

21. The electronic device of claim 16, wherein the controller refers to a table to determine whether to interpret the two or more key signals as the character not mapped to any of the two or more keys.
